(19) United States
(12) Patent Application Publication
(10) Pub. No.: US 2026/0265044 A1
(43) Pub. Date: Sep. 10, 2026

(54) LIQUID PUMPING APPARATUS

(71) Applicant: Shenzhen Glamortech Industrial Co., Ltd, Shenzhen (CN)

(72) Inventor: PENGBO MU, Huizhou (CN)

(21) Appl. No.: 19/660,521

(22) Filed: Apr. 28, 2026

(30) Foreign Application Priority Data
Apr. 1, 2026 (CN) 202620428900.4

(51) Int. Cl. B67D 7/42; B67D 7/04; B67D 7/08; B67D 7/84

(52) U.S. Cl. CPC B67D 7/42; B67D 7/04; B67D 7/08; B67D 7/84

(57) ABSTRACT

A liquid pumping apparatus is provided, including a pump head, a liquid charging gun, and a tube part. A tube passes through the gun and connects to the gun head. A holding part and body part form a hollow structure. The gun includes a battery compartment, anti-slip structure, and spring reset switch, and cooperates with a PCB and operation panel for on-off control. The tube is segmented with anti-slip ribs, hanging spaces, and a bent part, and can engage an oil filling port for hands-free use. The liquid channel cross section is designed to improve flowability. The pump head is a detachable housing with a motor and impeller. Components are sealed by sealing rings and silicone plugs. The apparatus is compact, anti-slip, easy to operate, reliable in sealing, low maintenance, improves space utilization and reduces volume, and is suitable for various liquid delivery scenarios with high efficiency and stability.

### TECHNICAL FIELD

The present disclosure relates to the field of liquid pumping, and in particular to an oil pump.

### BACKGROUND

There are many disadvantages in actual use of an existing liquid pumping apparatus. Key sealing parts such as a pump head, a tube connection end, and a circuit penetration position of the existing pumping apparatus are mainly designed by using a single sealing ring or a simple sealing gasket. The existing liquid pumping apparatus is simple in sealing manner and poor in sealing reliability. When corrosive or volatile liquid is transported, a problem of liquid leakage or liquid seepage is prone to occur, which not only causes liquid waste, but also causes potential safety hazards.

### SUMMARY

To overcome disadvantages in the prior art, the present disclosure provides a liquid pumping apparatus, including a pump head, a liquid charging gun, and a tube part, where the pump head includes a liquid pumping housing and a driving apparatus disposed in the liquid pumping housing; the liquid charging gun includes a control part, a body part, and a holding part, the holding part is connected to the body part to form a hollow structure, the holding part and the body part are integrally molded or detachably connected, the control part is electrically connected to the driving apparatus, and a through hole that runs through the body part is provided in the body part; and the tube part runs through the through hole through the through hole and passes through the holding part to be connected to the pump head.

Beneficial effects of the present disclosure as follows: The present disclosure provides a liquid pumping apparatus. The liquid pumping apparatus takes convenience of use, sealing reliability, and structural stability into account. The liquid pumping apparatus adapts to various liquid delivery scenarios. The tube part penetrates through the body part of the liquid charging gun and passes through the holding part to be directly connected to the pump head, and cooperates with a gravity center optimization design of the hollow structure, so that a gravity center of the apparatus is more attached to a holding position, and the apparatus can be stably held with a single hand to complete liquid pumping operation. The control part is directly electrically connected to the driving apparatus of the pump head, a signal transmission path is shorter, and control response is quicker. Precise control of liquid pumping on-off can be implemented without cooperation of both hands, and the other hand is completely liberated, thereby greatly improving operation efficiency of liquid pumping operation. The apparatus is particularly applicable to a scenario in which there is no auxiliary operation space.

### BRIEF DESCRIPTION OF THE DRAWINGS

To describe the technical solutions in the embodiments of the present disclosure more clearly, the following briefly describes the accompanying drawings required for describing the embodiments. The accompanying drawings in the following description show merely some embodiments of the present disclosure, and a person of ordinary skill in the art may derive other accompanying drawings from these accompanying drawings without creative efforts.

The present disclosure is further described in conjunction with the accompanying drawings and embodiments.

FIG. 1 is a structure diagram of a liquid pumping apparatus according to the present disclosure;

FIG. 2 is an exploded view of a first tube of a liquid pumping apparatus according to the present disclosure;

FIG. 3 is a structure diagram of a first silicone plug of a liquid pumping apparatus according to the present disclosure;

FIG. 4 is a structure diagram of a second tube of a liquid pumping apparatus according to the present disclosure;

FIG. 5 is a structure diagram of part G in FIG. 4;

FIG. 6 is a structure diagram of a third tube of a liquid pumping apparatus according to the present disclosure;

FIG. 7 is a sectional view of a liquid pumping apparatus according to the present disclosure;

FIG. 8 is a structure diagram of part H in FIG. 7;

FIG. 9 is a structure diagram of part I in FIG. 7;

FIG. 10 is an exploded view of a tube part of a liquid pumping apparatus according to the present disclosure;

FIG. 11 is a structure diagram of a liquid charging gun of a liquid pumping apparatus according to the present disclosure;

FIG. 12 is a structure diagram of part A in FIG. 11;

FIG. 13 is a structure diagram of a body part of a liquid pumping apparatus according to the present disclosure;

FIG. 14 is a structure diagram of part B in FIG. 13;

FIG. 15 is a structure diagram of a switch of a liquid pumping apparatus according to the present disclosure;

FIG. 16 is another structure diagram of a liquid charging gun of a liquid pumping apparatus according to the present disclosure;

FIG. 17 is a structure diagram of part C in FIG. 16;

FIG. 18 is a structure diagram of an operation panel of a liquid pumping apparatus according to the present disclosure;

FIG. 19 is a structure diagram of a PCB (Printed Circuit Board) of a liquid pumping apparatus according to the present disclosure;

FIG. 20 is a structure diagram of a holding part of a liquid pumping apparatus according to the present disclosure;

FIG. 21 is a sectional view of a liquid charging gun of a liquid pumping apparatus according to the present disclosure;

FIG. 22 is a structure diagram of part D in FIG. 21;

FIG. 23 is an exploded view of a liquid charging gun of a liquid pumping apparatus according to the present disclosure;

FIG. 24 is a structure diagram of a first body of a liquid pumping apparatus according to the present disclosure;

FIG. 25 is a structure diagram of part E in FIG. 24;

FIG. 26 is another structure diagram of a first body of a liquid pumping apparatus according to the present disclosure;

FIG. 27 is a structure diagram of part F in FIG. 26;

FIG. 28 is a structure diagram of an upper pump housing of a liquid pumping apparatus according to the present disclosure;

FIG. 29 is a structure diagram of a lower pump housing of a liquid pumping apparatus according to the present disclosure;

FIG. 30 is a structure diagram of an upper motor casing of a liquid pumping apparatus according to the present disclosure;

FIG. 31 is a structure diagram of a lower motor casing of a liquid pumping apparatus according to the present disclosure;

FIG. 32 is a structure diagram of a motor of a liquid pumping apparatus according to the present disclosure;

FIG. 33 is a structure diagram of an impeller of a liquid pumping apparatus according to the present disclosure;

FIG. 34 is a structure diagram of a motor end wire harness sealing gasket of a liquid pumping apparatus according to the present disclosure;

FIG. 35 is an exploded view of a pump head of a liquid pumping apparatus according to the present disclosure;

FIG. 36 is a sectional view of a pump head of a liquid pumping apparatus according to the present disclosure;

FIG. 37 is a structure diagram of part J in FIG. 36; and

FIG. 38 is a structure diagram of part K in FIG. 36.

### DETAILED DESCRIPTION OF THE EMBODIMENTS

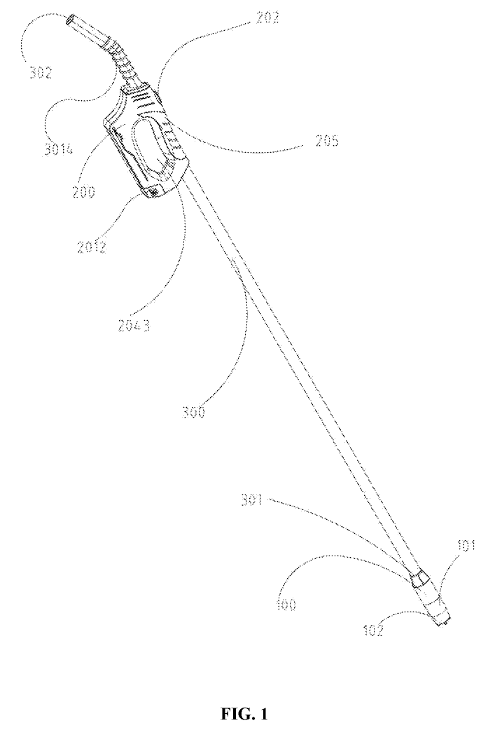

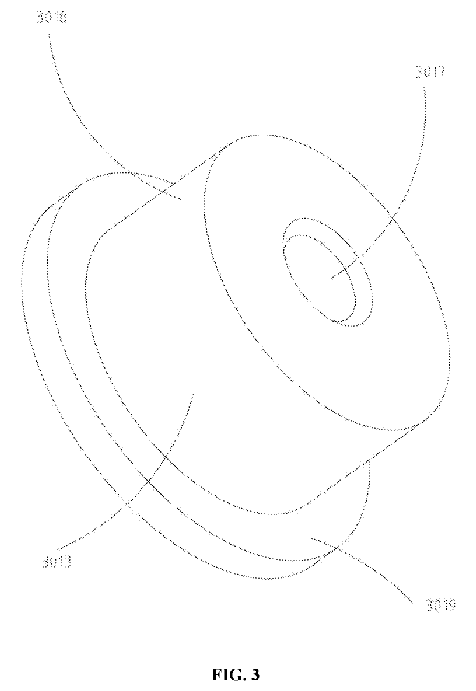

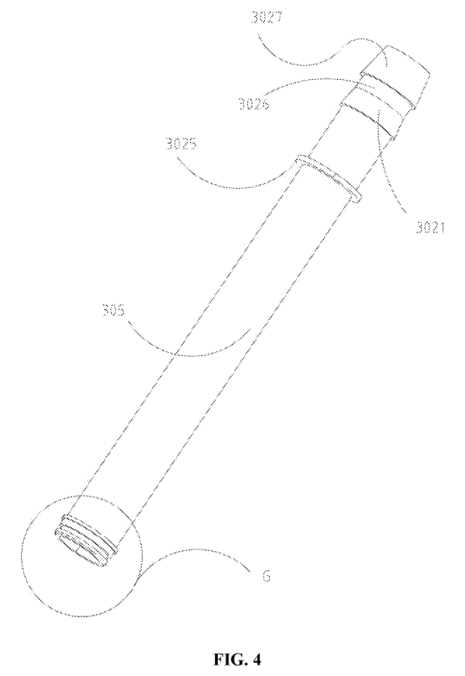

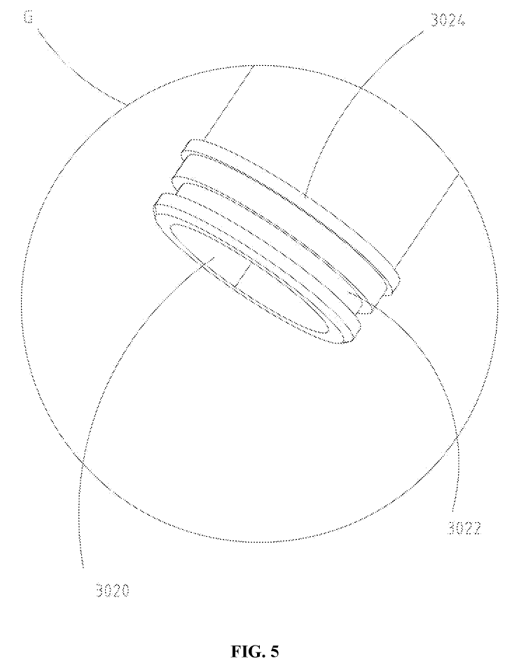

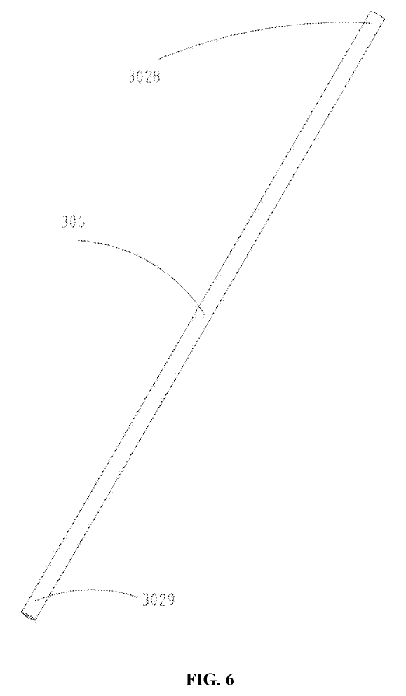

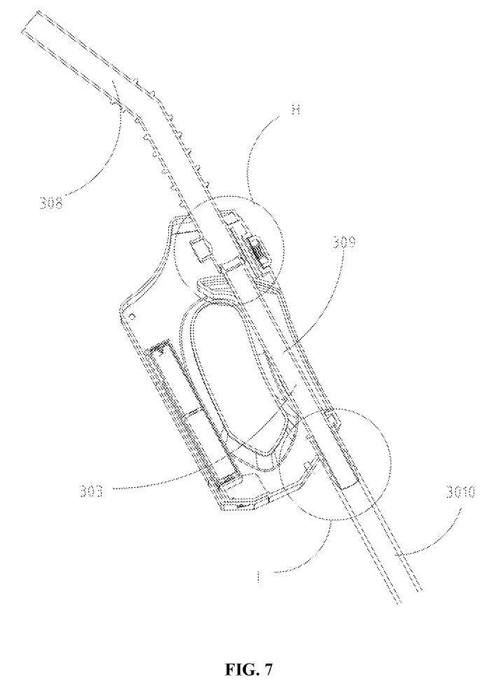

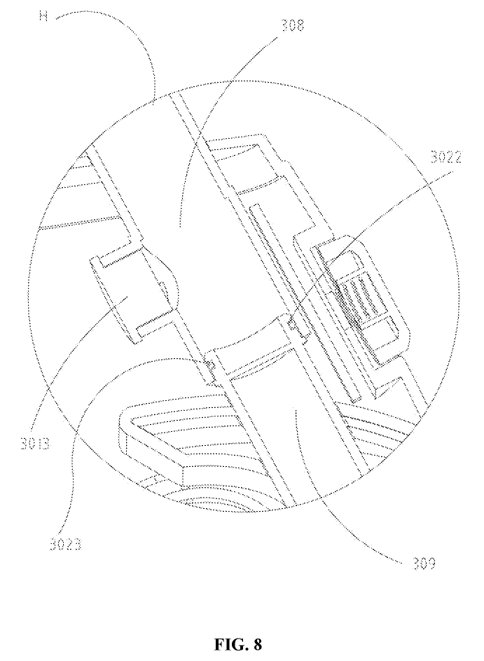

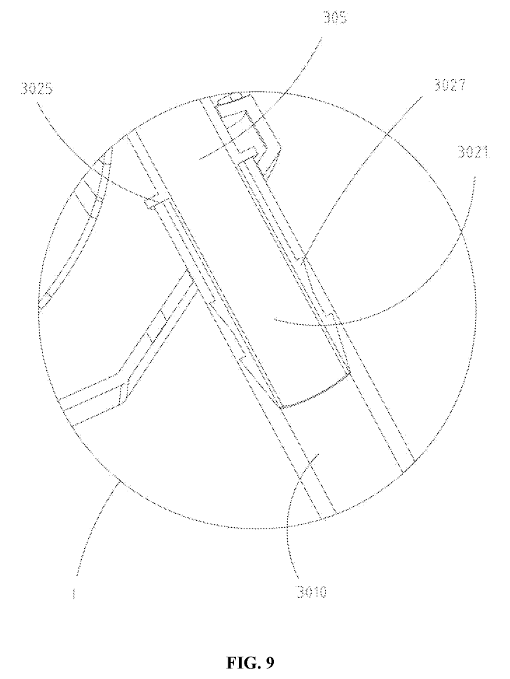

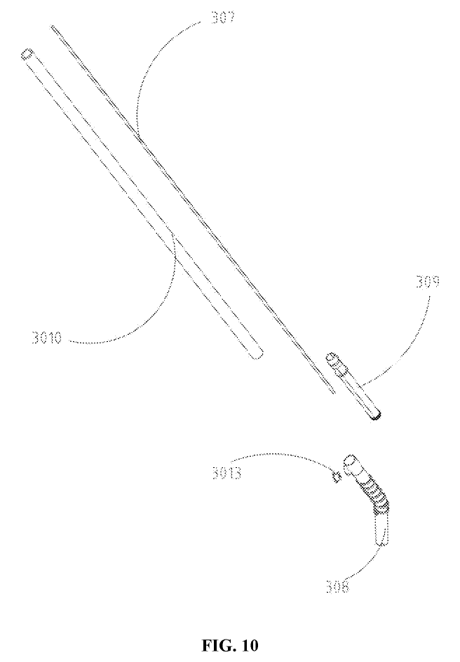

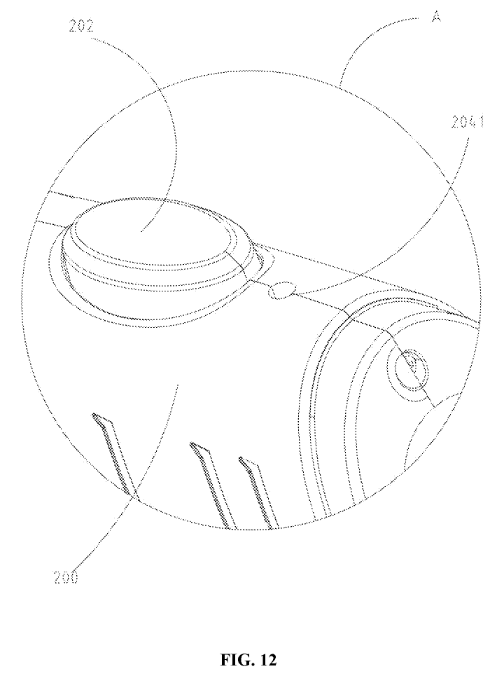

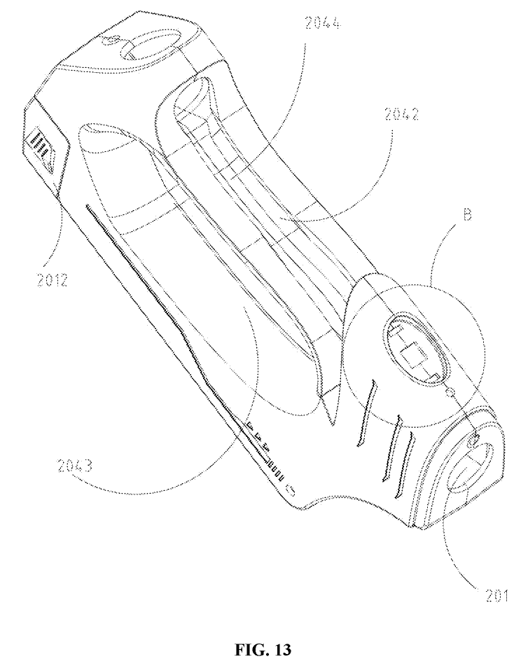

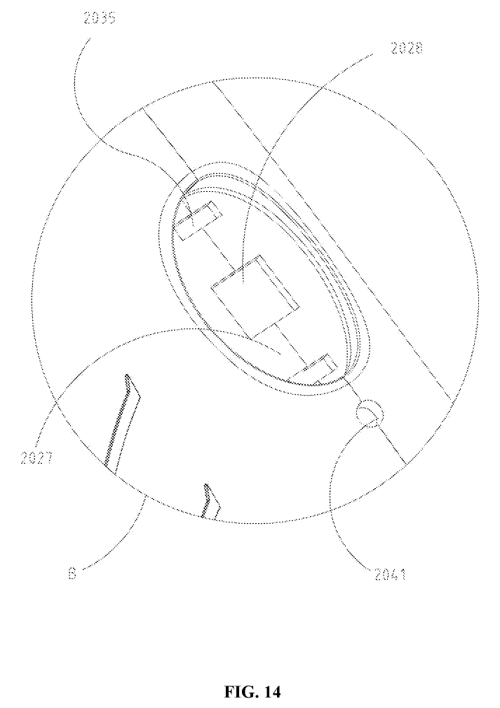

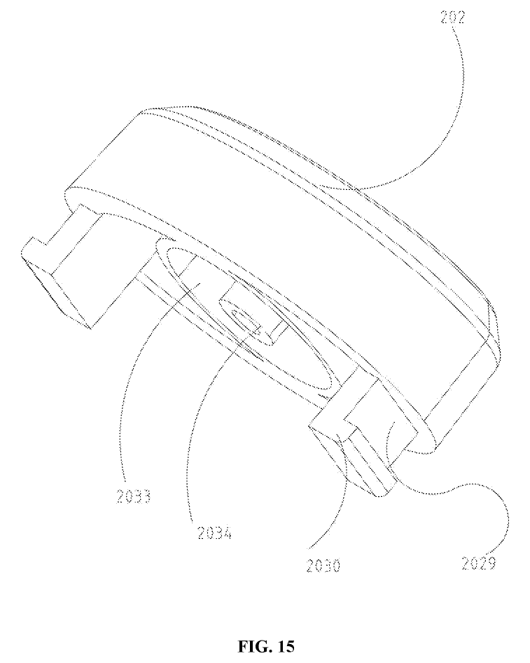

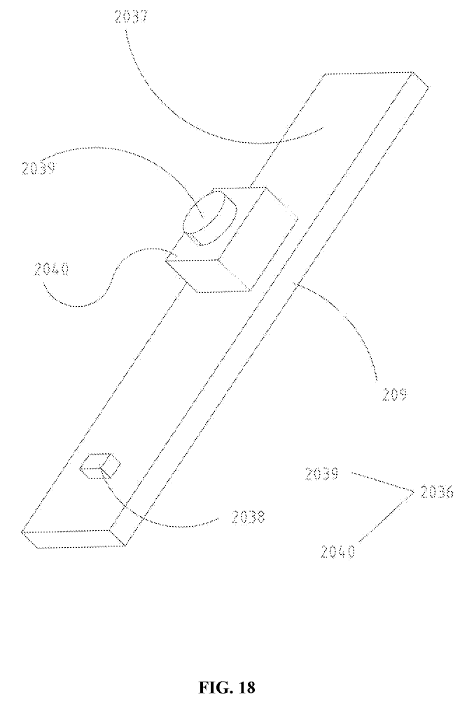

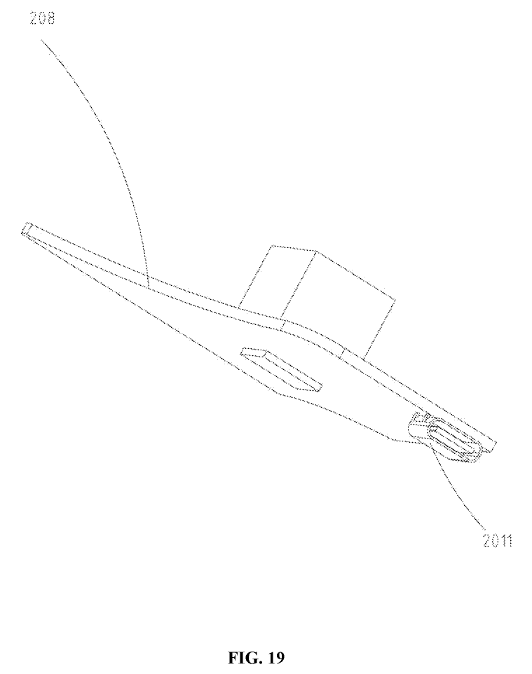

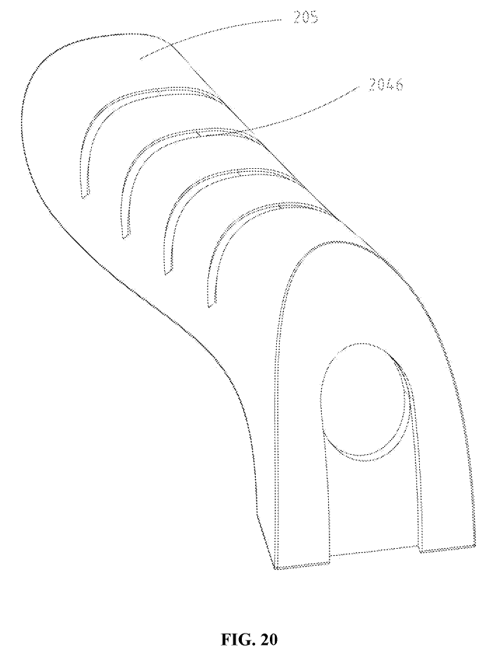

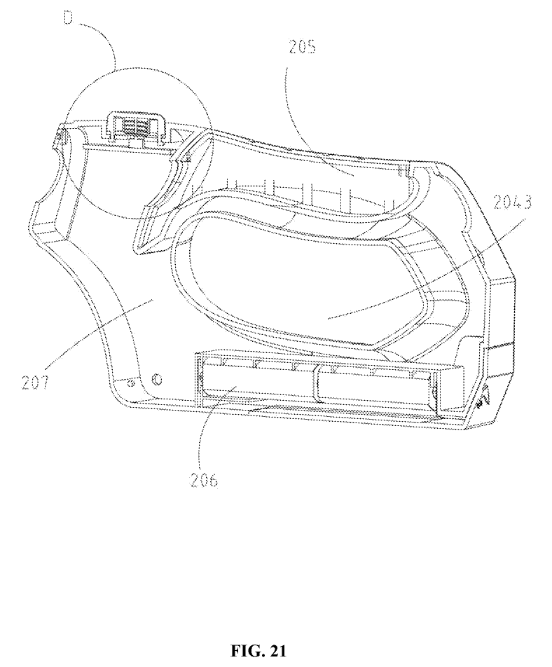

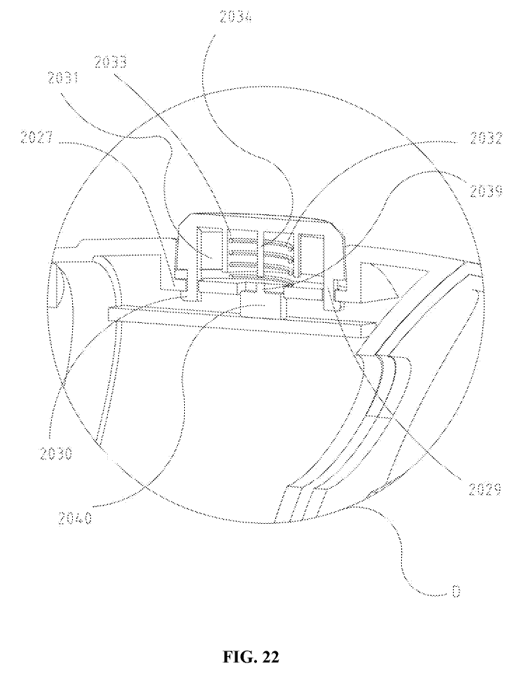

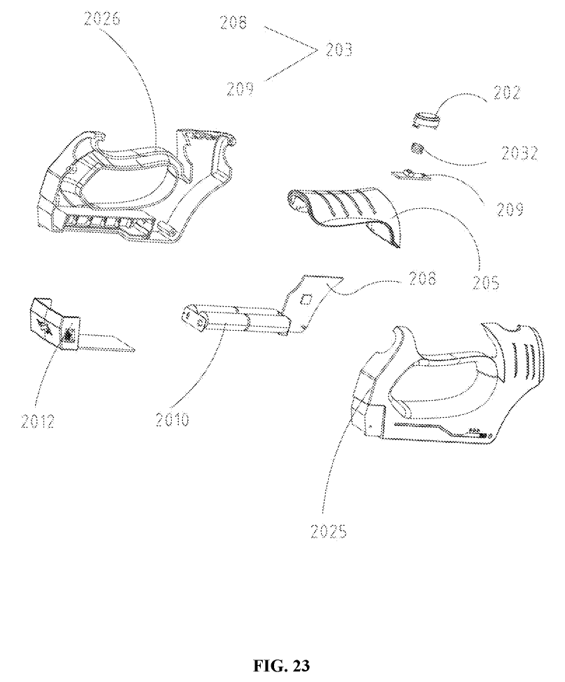

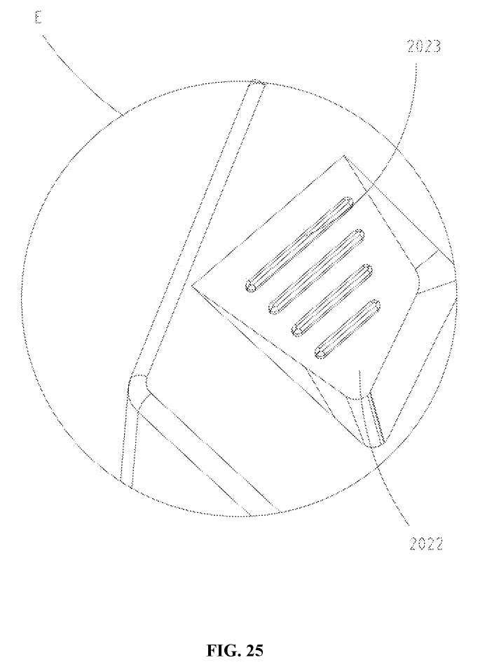

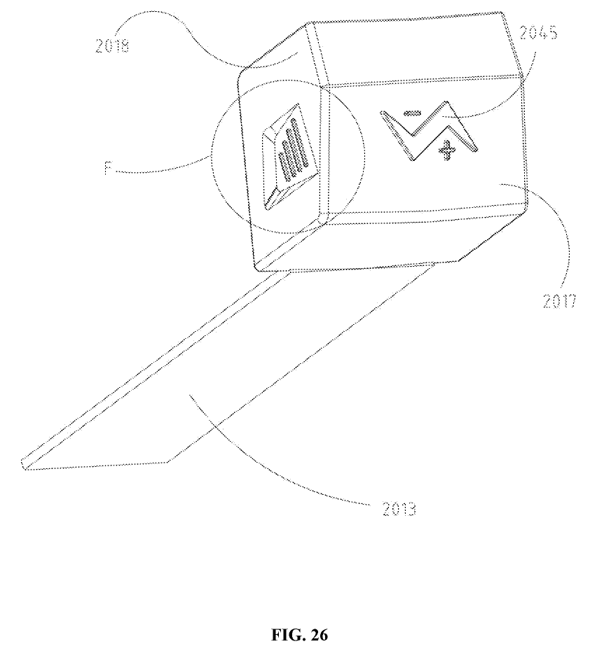

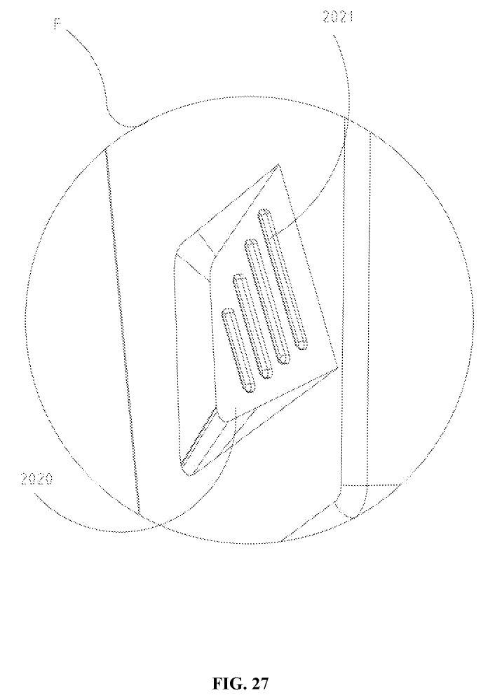

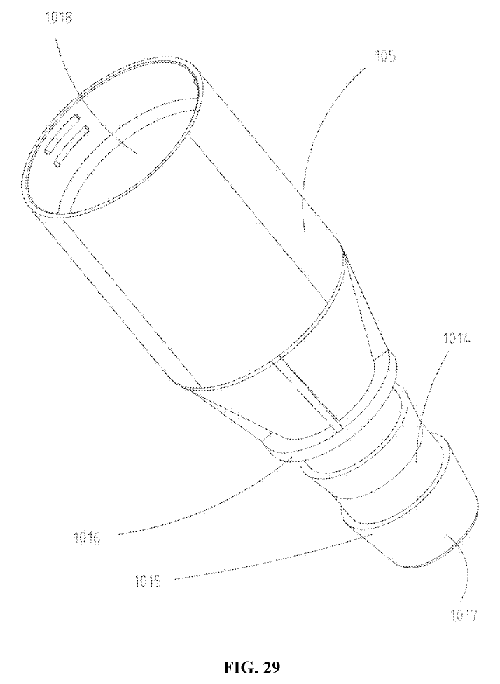

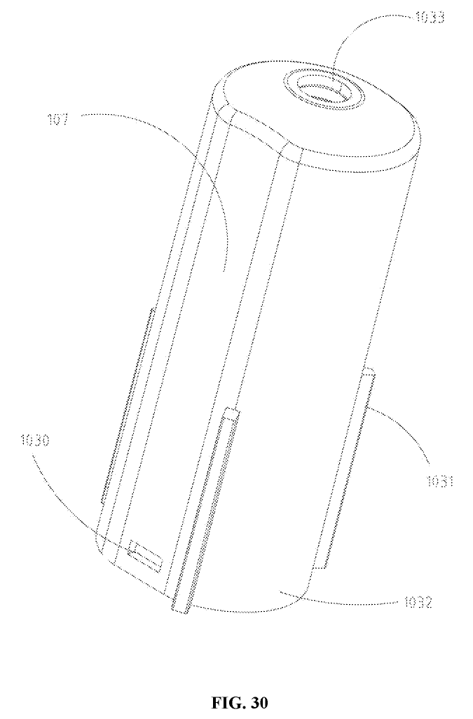

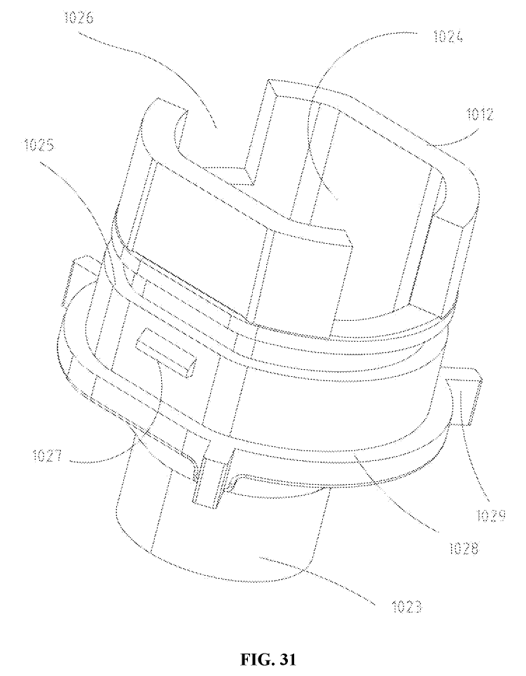

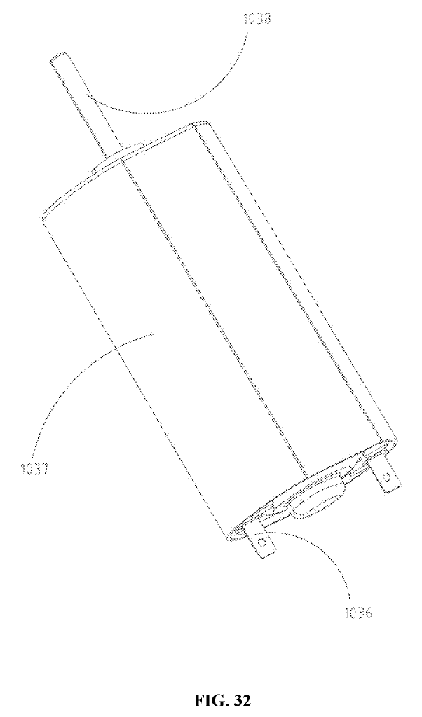

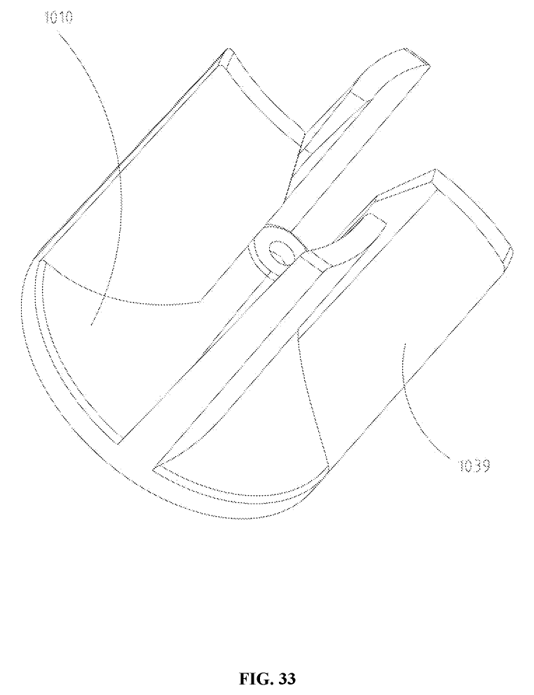

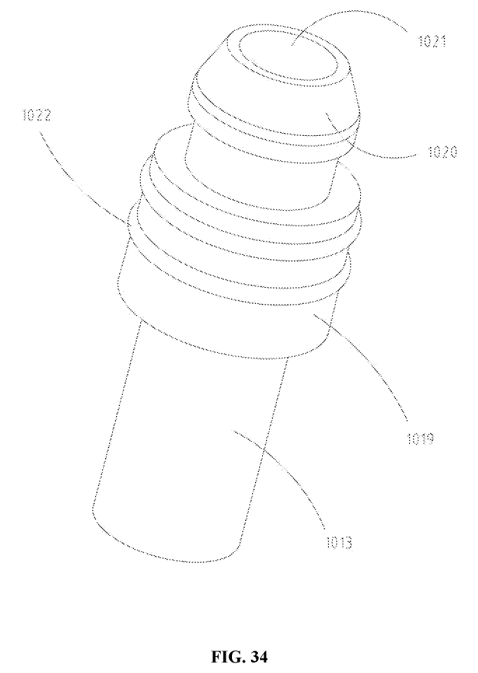

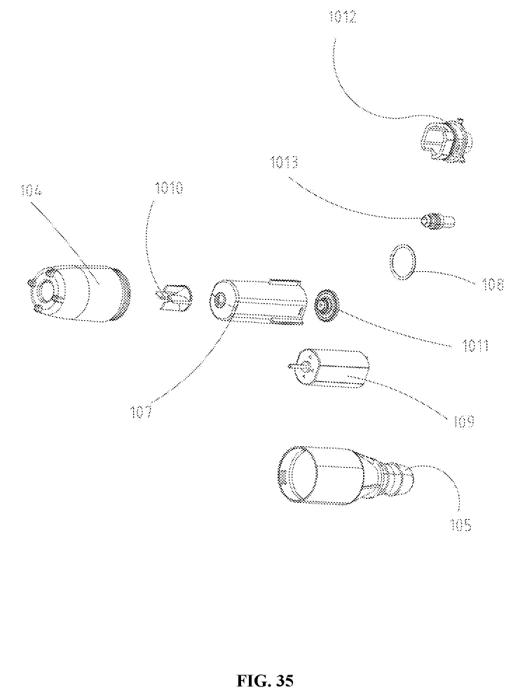

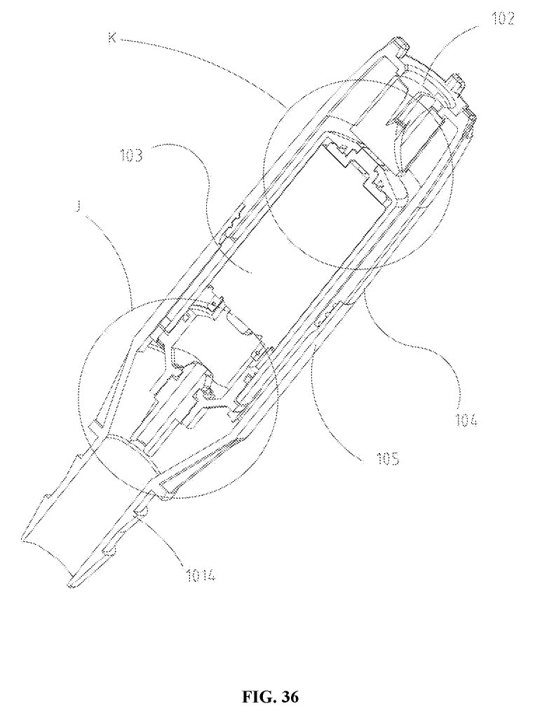

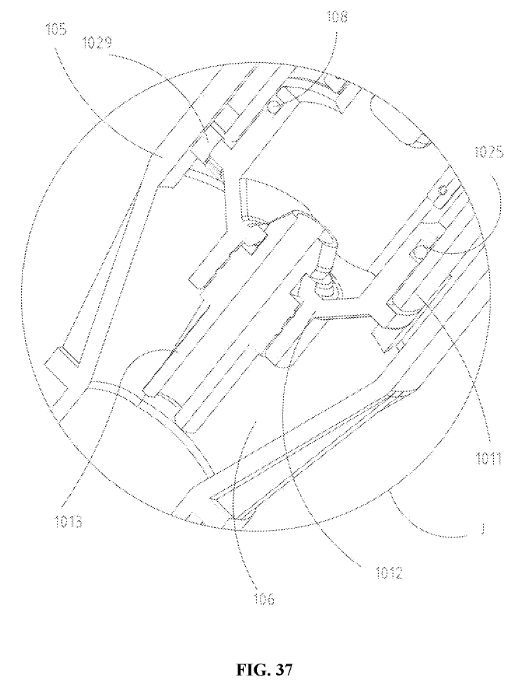

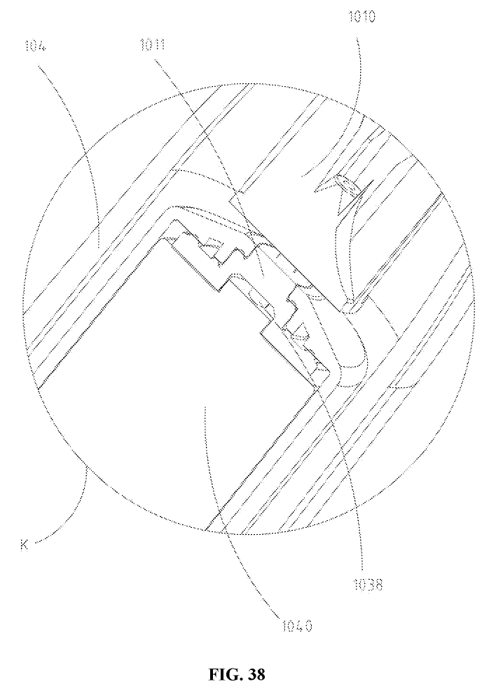

Referring to FIG. 1 to FIG. 38, a liquid pumping apparatus includes: a pump head 100, where the pump head 100 is configured to pump liquid, the pump head has a liquid pumping housing 101 and a liquid pumping port 102, and the liquid pumping housing includes a driving apparatus 103; a liquid charging gun 200, where the liquid charging gun 200 has a through hole 201, a switch 202, and a control part 203, the liquid charging gun 200 further includes a body part 204 and a holding part 205, the holding part 205 is connected to the body part 204, the holding part 205 and the body part 204 are integrally molded or detachably connected, the holding part 205 is connected to the body part 204 to form a hollow structure, the hollow structure is a frame structure, including but not limited to a square-loop structure and an O-shaped structure, the hollow structure has a first holding port 2043, and the first holding port 2043 is provided on a side of the liquid charging gun 200, so that a finger of a customer passes through the first holding port 2043 to preferably hold the liquid charging gun 200; the control part 203 is electrically connected to the driving apparatus 103, and the control part 203 is configured to control the driving apparatus 103; and a tube part 300, where the tube part 300 has an inlet 301, an outlet 302, and a liquid pumping channel 303 located between the inlet 301 and the outlet 302, the tube part 300 passes through the through hole 201 of the liquid charging gun 200 to be connected to the pump head 100, and the driving apparatus 103 drives liquid to pass through the inlet 301, the liquid pumping channel 303, and the outlet 302 in sequence from the liquid pumping port 102. According to the foregoing structures, the tube part 300 passes through the through hole 201, and a user holds the holding part 205 to turn on the driving apparatus 103 disposed in the pump head 100 by pressing the switch 202, so that the liquid passes through the inlet 301, the liquid pumping channel 303, and the outlet 302 in sequence from the liquid pumping port 102. The liquid pumping apparatus takes convenience of use, sealing reliability, and structural stability into account, and adapts to various liquid delivery scenarios. The liquid charging gun 200 is provided with the holding part 205 to increase a holding friction force, so that the liquid charging gun is not prone to slip during hand-holding operation and more comfortable in holding hand feeling, and the user does not get tired during operation for a long time, thereby improving use stability. The hollow structure can utilize structural space of the liquid charging gun 200 more efficiently, so that an overall structure of the liquid charging gun 200 is more compact and miniaturized.

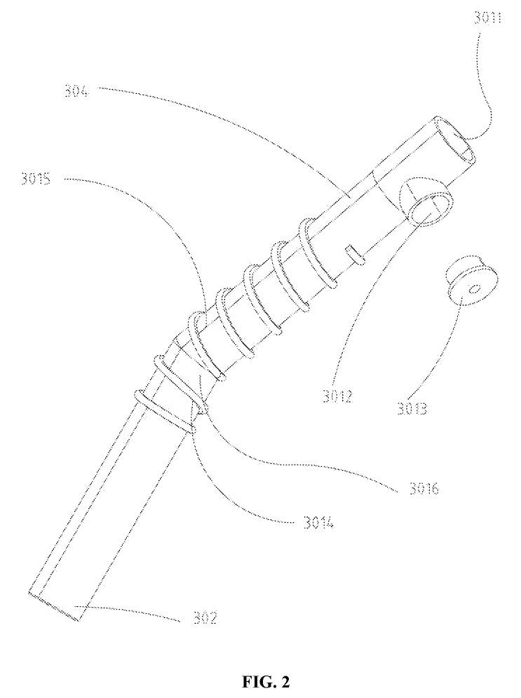

Referring to FIG. 2 to FIG. 10, in this embodiment, the tube part 300 includes a first tube 304, a second tube 305, and a third tube 306. The first tube 304, the second tube 305, and the third tube 306 are connected in sequence. Both the first tube 304 and the second tube 305 are rigid tubes, and the third tube 306 is a flexible tube. Hardness of the first tube 304 and the second tube 305 is greater than that of the third tube 306. The first tube 304, the second tube 305, and the third tube 306 are combined to form the liquid pumping channel 303. The liquid pumping channel 303 further includes a first wire 307. The first wire 307 is configured to connect the control part 203 and the pump head 100. The liquid pumping channel 303 includes a first channel 308, a second channel 309, and a third channel 3010. An area of an oil passage section of the second channel 309 is equal to an area of an oil passage section of the third channel 3010. The areas of the oil passage sections of the second channel 309 and the third channel 3010 are 176 mm². An area of an oil passage section of the first channel 308 is 1% to 5% greater than the areas of the oil passage sections of the second channel 309 and the third channel 3010.

The first tube 304 includes an outlet 302, a first connection port 3011, a second connection port 3012, and a first silicone plug 3013. The outlet 302 is provided at one end of the first tube 304, and the first connection port 3011 is provided at the other end of the first tube 304. The second connection port 3012 is provided on a side wall of the first tube 304. The first silicone plug 3013 is engaged with an interior of the second connection port 3012. The first tube 304 further includes first anti-slip ribs 3014, and the first anti-slip ribs 3014 are spirally disposed around the first tube 304. A plurality of hanging spaces 3015 are formed between the first anti-slip ribs 3014. When the liquid pumping apparatus is in use, the first anti-slip ribs 3014 are engaged with an oil filling port, and the hanging spaces 3015 are hung at the oil filling port. The first tube 304 further includes a bent part 3016, and a bent angle of the bent part 3016 is 30° to 120°. The bent part 3016 can be engaged with the oil filling port, so that the liquid pumping apparatus can be detached from an operator to be hung at the oil filling port.

The first silicone plug 3013 further includes a first opening 3017. The first opening 3017 runs through an upper surface of the first silicone plug 3013 to be in communication with a lower surface of the first silicone plug 3013. One end of the first wire 307 is connected to the control part 203, and the other end of the first wire 307 extends through the first opening 3017 into the tube part 300 and is connected to the pump head 100. An inner side wall of the first opening 3017 is extruded and sealed to an outer side wall of the first wire 307.

The first silicone plug 3013 further includes a first sealing boss 3018 and a first sealing platform 3019. The first sealing platform 3019 is circumferentially disposed below the first sealing boss 3018, and an outer side wall of the first sealing boss 3018 is extruded and sealed on an inner side wall of the second connection port 3012. The first sealing boss 3018 is located in the second connection port 3012, and the first sealing platform 3019 abuts against an edge of the second connection port 3012, so that the first sealing platform 3019 is extruded and sealed on the edge of the second connection port 3012.

The second tube 305 includes a first connection end 3020 and a second connection end 3021. The first connection end 3020 is configured to be connected to the first tube 304, and the second connection end 3021 is configured to be connected to the third tube 306. The first connection end 3020 includes a first clamping slot 3022, a first sealing ring 3023, and a second sealing platform 3024. The first sealing ring 3023 is disposed in the first clamping slot 3022. The first connection end 3020 is inserted in the first connection port 3011. The first sealing ring 3023 is configured to seal a gap between the first connection port 3011 and the first connection end 3020. The second sealing platform 3024 abuts against an end face of the second connection port 3012. The second sealing platform 3024 is disposed around a surface of the first connection end 3020.

The second connection end 3021 includes a third sealing platform 3025 and a first engaging head 3026. The third sealing platform 3025 is disposed around a surface of the second connection end 3021. The first engaging head 3026 includes at least one first guide head 3027. The first guide head 3027 is configured to guide the first engaging head 3026 to be inserted into the third tube 306, so that an inner side wall of the third tube 306 is extruded and sealed on an outer side wall of the first engaging head 3026, and the second tube 305 is prevented from disengaging from the third tube 306. The third sealing platform 3025 abuts against an end of the third tube 306.

The third tube 306 includes a third connection port 3028 and a fourth connection port 3029. The third connection port 3028 is provided at one end of the third tube 306. The first engaging head 3026 is inserted into the third connection port 3028. The fourth connection port 3029 is provided at the other end of the third tube 306. The fourth connection port 3029 is configured to connect the pump head 100. According to the foregoing structures, the first tube 304 is detachably connected to the second tube 305 and the third tube 306. The third tube 306 is a flexible third tube 306. Hardness of the first tube 304 and the second tube 305 is greater than that of the third tube 306. The first tube 304, the second tube 305, and the third tube 306 are combined to form the liquid pumping channel 303. The liquid pumping channel 303 includes the first channel 308, the second channel 309, and the third channel 3010. The area of the oil passage section of the second channel 309 is equal to the area of the oil passage section of the third channel 3010. The area of the oil passage section of the first channel 308 is 1% to 5% greater than the areas of the oil passage sections of the second channel 309 and the third channel 3010, so that an oil passage inside the liquid pumping channel 303 is more uniform, so as to implement smoother liquid flowability.

The liquid pumping channel 303 further includes a first wire 307, and the first wire 307 is configured to connect the control part 203 and the pump head 100. The second tube 305 is extruded and sealed with the first tube 304 and the third tube 306 to ensure sealing of the liquid pumping channel 303. The third tube 306 is made of a flexible material, so that bending adapts to different liquid pumping scenarios to absorb shock. The second tube 305 has higher hardness, and can play supporting and shaping roles, so as to prevent a middle part of the tube from collapsing and bending for flow blockage, thereby ensuring smooth flow passage and improving overall structure reliability. The tube part 300 is of a segmented structure that is easy to install but difficult to disassemble. When a certain segment is damaged, the damaged segment may be replaced separately and does not need to be replaced as a whole, thereby reducing use and maintenance costs. A plurality of hanging spaces 3015 are formed between the first anti-slip ribs 3014. When the liquid pumping apparatus is in use, the first anti-slip rib 3014 is engaged with the oil filling port, and the hanging spaces 3015 are hung at the oil filling port, so that the liquid pumping apparatus can be detached from the operator to be hung at the oil filling port. The plurality of hanging spaces 3015 can implement that the liquid pumping apparatus switches among a plurality of hanging positions. The first tube 304 further includes a bent part 3016. The bent part 3016 may be engaged with the oil filling port, so that the liquid pumping apparatus can be detached from the operator to be hung at the oil filling port.

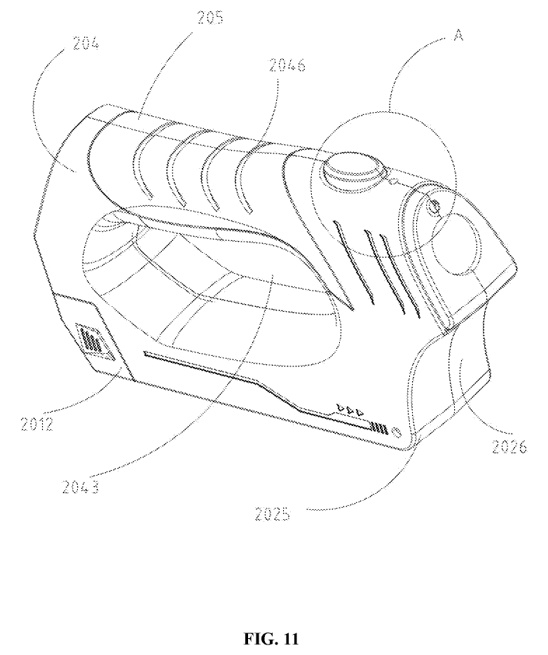

Referring to FIG. 11 to FIG. 27, in this embodiment, the body part 204 further includes a battery compartment 206 and a first accommodation space 207. The control part 203 is disposed in the first accommodation space 207. The battery compartment 206 is located below the body part 204. The control part 203 includes a PCB board 208 and an operation panel 209. The battery compartment 206 is internally provided with a detachable and replaceable battery 2010, and the PCB board 208 is electrically connected to the operation panel 209 and the battery compartment 206. The PCB board 208 includes a charging interface 2011, and the liquid pumping apparatus may supply power to the battery 2010 and/or supply power by using the charging interface 2011. The charging interface 2011 is a USB (Universal Serial Bus) interface and/or a Type-C interface. According to the foregoing structures, the liquid pumping apparatus may be powered by the battery 2010 and/or powered by the charging interface 2011, so as to implement two power supply manners. Moreover, rapid power supply can be implemented by replacing the battery 2010 without an external power supply.

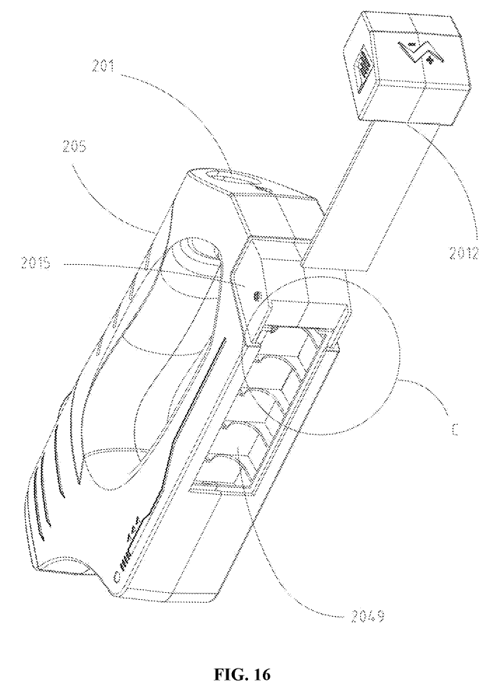

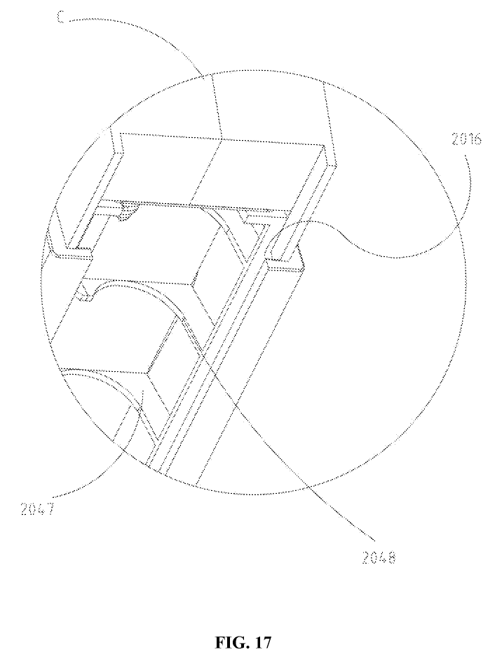

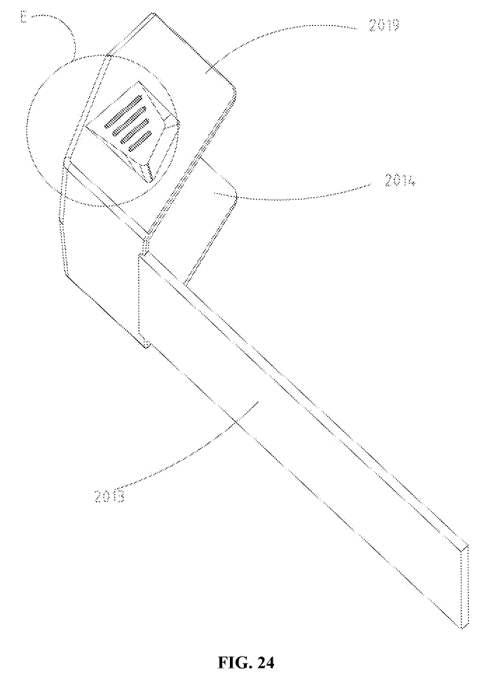

Referring to FIG. 16 and FIG. 17, and FIG. 24 to FIG. 27, in this embodiment, the liquid charging gun 200 further includes a first body 2012. The first body 2012 includes a first base plate 2013 and a first engaging part 2014 connected to the first base plate 2013. The first body 2012 is detachably connected to the body part 204 by using the first engaging part 2014. The battery compartment 206 is formed between the first body 2012 and the body part 204.

The body part 204 further includes a first engaging groove part 2015 corresponding to the first engaging part 2014, and a second clamping slot 2016 corresponding to the first base plate 2013, and the second clamping slot 2016 is provided on a bottom surface of the body part 204. The first engaging part 2014 includes a front side wall 2017, and a left side wall 2018 and a right side wall 2019 that are connected to the front side wall 2017. The left side wall 2018 includes a first holding groove 2020. The first holding groove 2020 includes a plurality of second anti-slip ribs 2021, and the plurality of second anti-slip ribs 2021 are arranged longitudinally. The right side wall 2019 includes a second holding groove 2022. The second holding groove 2022 includes a plurality of third anti-slip ribs 2023, and the plurality of third anti-slip ribs 2023 are arranged longitudinally. When the first body 2012 is connected to the body part 204, the first base plate 2013 is inserted into the second clamping slot 2016 to be engaged with the body part 204. The front side wall 2017, the left side wall 2018, and the right side wall 2019 abut against the first engaging part 2014. The front side wall 2017 further includes a first identifier part 2024, and the first identifier part 2024 includes at least one lightning-like identifier 2045 and identifiers of a plus sign and a minus sign. According to the foregoing structures, when the first body 2012 is connected to the body part 204, the first base plate 2013 is inserted into the second clamping slot 2016 to be engaged with the body part 204. The front side wall 2017, the left side wall 2018, and the right side wall 2019 abut against the first engaging part 2014. The second anti-slip rib 2021 and the third anti-slip rib 2023 implement firmer grasping when being configured to hold the first body 2012.

Referring to FIG. 11 to FIG. 27, in this embodiment, the body part 204 further includes a second body 2025 and a third body 2026. The second body 2025 is detachably connected to the third body 2026. The first accommodation space 207 is formed between the second body 2025 and the third body 2026. The body part 204 further includes a first slot 2027 provided on a surface of the body part 204, and a switch 202 disposed in the first slot 2027. The first slot 2027 further includes a plurality of first engaging ports 2035 and a second opening 2028. The second opening 2028 is provided in a center of the first slot 2027, and the plurality of first engaging ports 2035 are provided on both sides of the second opening 2028. The switch 202 further includes a plurality of first engaging members 2029 that are in a one-to-one correspondence with the plurality of first engaging ports 2035. A first limit block 2030 is disposed at an end of the first engaging member 2029, and the first limit block 2030 is configured to prevent the first engaging member 2029 from disengaging from the first engaging port 2035. A second accommodation space 2031 is formed between the switch 202 and the first slot 2027. A first spring 2032 is disposed in the second accommodation space 2031. The second opening 2028 is configured to enable the first accommodation space 207 to be in communication with the second accommodation space 2031.

The switch 202 further includes a second slot 2033. The second slot 2033 is provided at a bottom of the switch 202. A first limit post 2034 is disposed in a center of the second slot 2033. One end of the first spring 2032 is sleeved on the first limit post 2034 and is engaged with the second slot 2033, and the other end of the first spring 2032 abuts against the first slot 2027. The first limit post 2034 is configured to limit a position of the first spring 2032, so that the first spring 2032 is fixed in the second accommodation space 2031.

The switch 202 may move between a first position and a second position. When the switch 202 is in the first position, the first spring 2032 is in a compressed state, and a lower surface of the switch 202 abuts against the first slot 2027. When the switch 202 is in the second position, the first spring 2032 is in a stretched state, the first limit block 2030 abuts against the body part 204, and the first spring 2032 is configured to reset the switch 202 from the second position to the first position. According to the foregoing structures, the switch 202 may move between the first position and the second position. When the switch 202 is in the first position, the first spring 2032 is in the compressed state, and the lower surface of the switch 202 abuts against the first slot 2027. When the switch 202 is in the second position, the first spring 2032 is in the stretched state, the first limit block 2030 abuts against the body part 204, and the first spring 2032 is configured to reset the switch 202 from the second position to the first position.

Referring to FIG. 11 to FIG. 27, in this embodiment, the operation panel 209 is disposed below the first slot 2027. The operation panel 209 includes a first button 2036, a first plate body 2037, and a first indicator light 2038. The first button 2036 includes a first push button 2039 and a first support boss 2040, and the first push button 2039 is disposed above the first support boss 2040. The first support boss 2040 is disposed above the first plate body 2037. The first push button 2039 passes through the second opening 2028 to be disposed in second accommodation space 2031. When the switch 202 is in the first position, the first limit post 2034 abuts against the first push button 2039, so that the operation panel 209 generates a first signal, and the first indicator light 2038 is turned on. The operation panel 209 transmits the first signal to the PCB board 208 by using the first wire 307. After receiving the first signal, the PCB board 208 controls the liquid pumping apparatus to be turned on.

When the liquid pumping apparatus is in a turn-on state and the switch 202 is in the first position, the first limit post 2034 abuts against the first push button 2039, so that the operation panel 209 generates a second signal, and the first indicator light 2038 is turned off. The operation panel 209 transmits the second signal to the PCB board 208 by using the first wire 307. After receiving the second signal, the PCB board 208 controls to the liquid pumping apparatus to be turned off.

The body part 204 further includes a twelfth opening 2041. The twelfth opening 2041 is provided above the first indicator light 2038, and the twelfth opening 2041 is configured to transmit a light source generated by the first indicator light 2038 to the outside, so as to observe whether the liquid pumping apparatus is in the turn-on state. According to the foregoing structures, when the liquid pumping apparatus is in the turn-on state and the switch 202 is in the first position, the first limit post 2034 abuts against the first push button 2039, so that the operation panel 209 generates a second signal, and the first indicator light 2038 is turned off. The operation panel 209 transmits the second signal to the PCB board 208 by using the first wire 307. After receiving the second signal, the PCB board 208 controls the liquid pumping apparatus to be turned off. The twelfth opening 2041 is configured to transmit the light source generated by the first indicator light 2038 to the outside, so as to observe whether the liquid pumping apparatus is in the turn-on state.

Referring to FIG. 11 to FIG. 27, in this embodiment, the holding part 205 is detachably connected to the body part 204. The body part 204 further includes a third clamping slot 2042 and a first holding port 2043. The holding part 205 is engaged with the third clamping slot 2042. The third clamping slot 2042 further includes a first groove part 2044. The first groove part 2044 is configured to accommodate the second tube 305. The holding part 205 is located above the first holding port 2043, and covers the third clamping slot 2042. The holding part 205 is a holding part 205 of a silicon rubber material. The holding part 205 further includes a plurality of first anti-slip grooves 2046, and the plurality of first anti-slip grooves 2046 are arranged on an upper surface of the holding part 205 transversely. According to the foregoing structures, the holding part 205 is detachably connected to the body part 204. The holding part 205 is engaged with the third clamping slot 2042. The holding part 205 is located above the first holding port 2043, and covers the third clamping slot 2042. The holding part 205 includes but is not limited to the holding part 205 of the silicon rubber material. The holding part 205 further includes the plurality of first anti-slip grooves 2046. The plurality of first anti-slip grooves 2046 are arranged on the upper surface of the holding part 205 transversely. The plurality of first anti-slip grooves 2046 increase friction of the holding part 205, so as to implement a better anti-slip effect.

Referring to FIG. 16 and FIG. 17, in this embodiment, the battery compartment 206 further includes a plurality of locking plates 2047. The plurality of locking plates 2047 are disposed on two sides of the battery compartment 206. The locking plate 2047 includes a first limit slot 2048. A first limit space 2049 is formed between the plurality of locking plates 2047 and the first limit slot 2048, and the first limit space 2049 is configured to limit the battery 2010 in the battery compartment 206 and maintain stability. According to the foregoing structures, the first limit space 2049 is formed between the first limit slots 2048 of the plurality of locking plates 2047, and the first limit space 2049 is configured to limit the battery 2010 in the battery compartment 206 and maintain the stability.

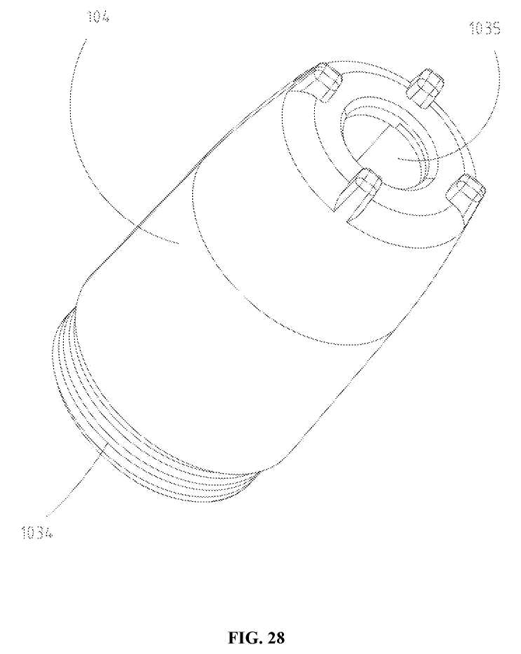

Referring to FIG. 28 to FIG. 38, in this embodiment, the liquid pumping housing 101 includes an upper pump housing 104 and a lower pump housing 105. The upper pump housing 104 is detachably connected to the lower pump housing 105, so as to facilitate cleaning of an inside of the pump head 100. The upper pump housing 104 and the lower pump housing 105 may be in threaded connection by using threads, and a third accommodation space 106 is formed between the upper pump housing 104 and the lower pump housing 105, and the third accommodation space 106 is configured to accommodate the driving apparatus 103. According to the foregoing structures, the liquid pumping housing 101 includes the upper pump housing 104 and the lower pump housing 105. The upper pump housing 104 is detachably connected to the lower pump housing 105. The upper pump housing 104 and the lower pump housing 105 may be in threaded connection by using the threads. The third accommodation space 106 is formed between the upper pump housing 104 and the lower pump housing 105. The third accommodation space 106 is configured to accommodate the driving apparatus 103.

Referring to FIG. 28 to FIG. 38, in this embodiment, the driving apparatus 103 includes an upper motor casing 107, a second sealing ring 108, a motor 109, an impeller 1010, an upper motor casing sealing gasket 1011, a lower motor casing 1012, and a motor end wire harness sealing gasket 1013. The lower pump housing 105 further includes a second engaging head 1014. The second engaging head 1014 is disposed at an end that is of the lower pump housing 105 and that is close to the fourth connection port 3029. The second engaging head 1014 includes a second guide head 1015 and a fourth sealing platform 1016. The quantity of the second guide heads 1015 is at least one. The second guide head 1015 is disposed at one end of the second engaging head 1014, and the second guide head 1015 is configured to guide the second engaging head 1014 to be inserted into the third tube 306, so that an inner side wall of the third tube 306 is extruded and sealed on an outer side wall of the second engaging head 1014. The fourth sealing platform 1016 abuts against an end of the third tube 306. The lower pump housing 105 further includes a third opening 1017 and a fourth opening 1018. The third opening 1017 is provided at one end that is of the lower pump housing 105 and that is close to the second engaging head 1014. The fourth opening 1018 is provided at one end that is of the lower pump housing 105 and that is close to the upper pump housing 104. The motor end wire harness sealing gasket 1013 is detachably connected to the lower pump housing 105. One end of the motor end wire harness sealing gasket 1013 is engaged with the third opening 1017. The motor end wire harness sealing gasket 1013 includes an abutting part 1019, a third engaging head 1020, and a fifth opening 1021 that runs through the motor end wire harness sealing gasket 1013. The abutting part 109 is disposed on a surface of the motor end wire harness sealing gasket 1013. The abutting part 1019 includes a plurality of abutting rings 1022. The plurality of abutting rings 1022 are disposed around a surface of the abutting part 1019. The third engaging head 1020 is a conical third engaging head 1020.

The lower motor casing 1012 includes a sixth opening 1023, a seventh opening 1024, a fourth clamping slot 1025, a plurality of fifth clamping slots 1026, a plurality of first engaging blocks 1027, a fifth sealing platform 1028, and a plurality of first abutting blocks 1029 extending from the fifth sealing platform 1028. A radius of the sixth opening 1023 is greater than that of the seventh opening 1024. The sixth opening 1023 is provided at one end away from the third tube 306. The seventh opening 1024 is provided at one end close to the third tube 306. The plurality of first engaging blocks 1027 are disposed on two sides of the lower motor casing 1012. The fourth clamping slot 1025 is provided around the lower motor casing 1012, and the second sealing ring 108 is engaged with the fourth clamping slot 1025. The plurality of fifth clamping slots 1026 are provided on two sides of the lower motor casing 1012. When the motor end wire harness sealing gasket 1013 is connected to the lower motor casing 1012, the other end of the motor end wire harness sealing gasket 1013 is engaged with the seventh opening 1024. When the motor end wire harness sealing gasket 1013 is engaged with the seventh opening 1024, the plurality of abutting rings 1022 abut against an inner wall of the seventh opening 1024, so as to implement good sealing connection.

The upper motor casing 107 includes a plurality of sixth slots 1030 corresponding to the plurality of first engaging blocks 1027, and a plurality of second abutting blocks 1031 corresponding to the plurality of first abutting blocks 1029. The upper motor casing 107 is detachably connected to the lower motor casing 1012. The upper motor casing 107 further includes an eighth opening 1032 and a ninth opening 1033. The eighth opening 1032 is provided at one end that is of the upper motor casing 107 and that is close to the lower motor casing 1012. The ninth opening 1033 is provided at one end that is of the upper motor casing 107 and that is away from the lower motor casing 1012. When the upper motor casing 107 is connected to the lower motor casing 1012, the eighth opening 1032 is sleeved outside of the lower motor casing 1012. The plurality of first engaging blocks 1027 are engaged with the plurality of sixth slots 1030. One end of the upper motor casing 107 abuts against the fifth sealing platform 1028, so that the upper motor casing 107 and the lower motor casing 1012 implement sealing connection.

The plurality of first abutting blocks 1029 and the plurality of second abutting blocks 1031 are configured to abut against an inner wall of the third accommodation space 106, so that the upper motor casing 107 and the lower motor casing 1012 remain stable in the third accommodation space 106.

The upper pump housing 104 includes a tenth opening 1034 and an eleventh opening 1035. The tenth opening 1034 is provided at one end that is of the upper pump housing 104 and that is close to the lower pump housing 105. The eleventh opening 1035 is provided at one end that is of the upper pump housing 104 and that is away from the lower pump housing 105. A radius of the tenth opening 1034 is greater than that of the eleventh opening 1035. The eleventh opening 1035 is configured to pump the liquid into the liquid pumping apparatus.

A fourth accommodation space 1040 is formed between the upper motor casing 107 and the lower motor casing 1012, and the fourth accommodation space 1040 is configured to accommodate the motor 109, the upper motor casing sealing gasket 1011, and the impeller 1010.

The motor 109 includes a plurality of electrode terminals 1036, a motor body 1037, and a drive shaft 1038. The upper motor casing sealing gasket 1011 and the impeller 1010 are sleeved on the drive shaft 1038. The impeller 1010 at least includes one blade 1039. One end of the first wire 307 is connected to the control part 203. According to the foregoing structures, the other end of the first wire 307 successively passes through the first opening 3017, the first tube 304, the second tube 305, the third tube 306, the lower pump housing 105, the motor end wire harness sealing gasket 1013, and the lower motor casing 1012 to be connected to the motor 109, so as to implement control for the pump head 100.

As described above, one or more embodiments are provided in combination with concrete content, and the specific implementation of the present disclosure is not intended to be limited to these descriptions. Approximate and similar methods and structures in the present disclosure, or a plurality of technical deductions and substitutions can be made without departing from the concept of the present disclosure, and should be regarded as the scope of protection of the present disclosure.

What is claimed is:

1. A liquid pumping apparatus, comprising a pump head, a liquid charging gun, and a tube part, wherein
the pump head comprises a liquid pumping housing and a driving apparatus disposed in the liquid pumping housing;
the liquid charging gun comprises a control part, a body part, and a holding part, the holding part is connected to the body part to form a hollow structure, the control part is electrically connected to the driving apparatus, and a through hole that runs through the body part is provided in the body part; and
the tube part passes through the through hole and the holding part to be connected to the pump head.

2. The liquid pumping apparatus according to claim 1, wherein the body part further comprises a battery compartment, the holding part is disposed on one side of the hollow structure, and the battery compartment is disposed on the other side of the hollow structure.

3. The liquid pumping apparatus according to claim 1, wherein the tube part comprises a first tube, a second tube, and a third tube that are connected in sequence; and
the first tube comprises first anti-slip ribs, the first anti-slip ribs are disposed around an outer surface of the first tube, and a plurality of hanging spaces configured to be hung on an oil filling port are formed between the first anti-slip ribs.

4. The liquid pumping apparatus according to claim 1, wherein the liquid charging gun further comprises a first body, the first body comprises a first base plate and a first engaging part connected to the first base plate, and the first body is detachably connected to the body part by using the first engaging part.

5. The liquid pumping apparatus according to claim 1, wherein the body part further comprises a second body and a third body, the second body is detachably connected to the third body, a first accommodation space is formed between the second body and the third body, and the control part is disposed in the first accommodation space.

6. The liquid pumping apparatus according to claim 1, wherein the control part comprises a PCB (Printed Control Board) and an operation panel, a first slot is provided on a surface of the body part, a switch is built in the first slot, a first spring is disposed between the switch and the first slot, the switch is movable between a first position and a second position, and the first spring resets the switch from the second position to the first position; and the operation panel is disposed below the first slot, the operation panel comprises a first button, and when the switch penetrates into the first slot to abut against the first button, the switch presses the first button to cause the operation panel to generate a control signal, so as to implement on-off control of the liquid pumping apparatus.

7. The liquid pumping apparatus according to claim 1, wherein the liquid pumping housing comprises an upper pump housing and a lower pump housing, and the upper pump housing is detachably connected to the lower pump housing.

8. The liquid pumping apparatus according to claim 1, wherein the holding part and the body part are integrally molded or detachably connected.

9. The liquid pumping apparatus according to claim 2, wherein the battery compartment further comprises a plurality of locking plates, the plurality of locking plates are disposed on two sides of the battery compartment, the locking plate comprises a first limit slot, a first limit space is formed between the first limit slots of the plurality of locking plates, and the first limit space is used to install a power supply.

10. The liquid pumping apparatus according to claim 3, wherein both the first tube and the second tube are rigid tubes, and the third tube is a flexible third tube.
